(19) United States
(12) Patent Application Publication
(10) Pub. No.: US 2010/0255139 A1
(43) Pub. Date: Oct. 7, 2010

(54) MICROPATTERN TRANSFER STAMPER AND MICROPATTERN TRANSFER DEVICE

(76) Inventors: Ryuta WASHIYA, Hitachi (JP); Masahiko Ogino, Hitachi (JP); Noritake Shizawa, Ninomiya (JP); Kyoichi Mori, Oiso (JP); Akihiro Miyauchi, Hitachi (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 12/752,808

(22) Filed: Apr. 1, 2010

(30) Foreign Application Priority Data
Apr. 3, 2009 (JP) 2009-090587

(51) Int. Cl. B29C 59/02

(52) U.S. Cl. 425/405.1

(57) ABSTRACT

A micropattern transfer stamper has a space that hermetically contains fluid, on an opposite side of a surface with an indented pattern formed thereon of a pattern forming sheet member. The pattern forming sheet member is convexly bent by pressure of the fluid contained in the space. When the indented pattern is transferred onto the material to be transferred, the pattern forming sheet member deforms following the surface of the material to be transferred.

### CROSS REFERENCE TO RELATED APPLICATIONS

This application claims the benefit of Japanese Patent Application No. 2009-090587 filed on Apr. 3, 2009, the disclosure of which is incorporated herein by reference.

### BACKGROUND OF THE INVENTION

1. Field of the Invention

The present invention relates to a micropattern transfer stamper and a micropattern transfer device for transferring a fine indented pattern, onto a surface of a material to be transferred.

2. Description of the Related Art

Semiconductor integrated circuits have been made extremely smaller in recent years. When patterns of such extremely small circuits are formed, a high degree of accuracy is required in, for example, photolithography. However, micro-fabrication of those circuits with a high accuracy is now approaching its limit, because a scale of the micro-fabrication has nearly reached a wavelength of an exposing source itself for use in the micro-fabrication. To obtain an even higher accuracy, an electron beam writing technique, which is a technique relevant to a charged particle beam apparatus, has also been used instead of photolithography.

However, in forming patterns of extremely small circuits with the electron beam writing technique, the more patterns are drawn, the more time it takes for exposure, unlike a one-shot exposure with an exposing source such as an i-ray and an excimer laser. Hence, the more integrated the circuits become, the more time it takes for forming patterns. This results in a poor throughput.

To speed up the formation of patterns using an electron beam writing apparatus, a technique of electron beam cell projection lithography has been developed, in which electron beams are irradiated en bloc on a plurality of combined masks having various shapes. However, such an electron beam writing apparatus for use in the electron beam cell projection lithography is necessarily large-sized and high-priced, because a structure of the apparatus becomes more complex, and a mechanism for controlling each position of the masks with a higher accuracy is required.

In forming patterns of extremely small circuits, imprint lithography has also been known as another technique, in which a stamper having a fine pattern complementary to a desired one is stamped onto a surface of a material to be transferred (To simplify descriptions, even after a pattern is transferred on a material to be transferred, the material to be transferred is still referred to as the “material to be transferred” hereinafter). The material to be transferred is, for example, a substrate having a resin layer thereon. The imprint lithography can transfer a micropattern having an indented width on a 25 nm scale or less onto the above-described resin layer on the substrate as a material to be transferred. More specifically, the resin layer (which may also be referred to as a “pattern forming layer”) includes a thin film layer formed on the substrate and a patterned layer composed of protrusions formed on the thin film layer. The imprint lithography has also been applied to creation of a pattern of recording bits for a large capacity recording medium and of a pattern of a semiconductor integrated circuit. For example, a mask for fabricating a large capacity recording medium substrate or a semiconductor integrated circuit substrate can be prepared by: using protrusions of a pattern forming layer formed with the imprint lithography, as a mask; and etching portions of a thin film layer that expose as recesses of the pattern forming layer, and portions of a substrate that are immediately under the portions of the thin film layer.

Precision of etching at a substrate is affected by a distribution of thickness in a surface direction of a thin film layer. For example, assume a case where a thin film layer of a material to be transferred has a thickness difference of 50 nm between the maximum and the minimum. If the thin film layer is etched at a depth of 50 nm, a substrate is etched in a portion having a small thickness of the thin film layer. On the other hand, the substrate is not etched in a portion having a large thickness of the thin film layer. This means that, in order to ensure a prescribed precision of etching, the thickness of a thin film layer formed on a substrate needs to be uniform. In forming such a thin film layer having a uniform thickness, a resin layer formed on a substrate is required to have a small and uniform thickness in its surface direction.

In the conventional imprinting technique, a pattern is typically created by pressing a flat stamper against a flat material to be transferred. In the technique, however, when the material to be transferred comes in contact with the stamper, their entire contact surfaces come in contact with each other virtually simultaneously. Some portion on the contact surfaces may be therefore subjected to local pressure. This prevents smooth flowability of a resin or allows air bubble entrainment into the resin. In that case, a pattern forming film obtained becomes partially nonuniform. The larger an area in the pattern forming film on which a pattern is transferred, the more nonuniform the pattern forming film becomes.

There has been known a transfer device in which a flat stamper is convexly bent and is brought in contact with a material to be transferred (see, for example, Japanese Laid-Open Patent Application, Publication No. H08-207159 (to be referred to as Reference 1 hereinafter) and Japanese Laid-Open Patent Application, Publication No. 2006-303292 (to be referred to as Reference 2 hereinafter)). In the transfer device, a convex-shaped top portion of the stamper comes in contact first with a center portion of the material to be transferred. Then, the contacted part therebetween is more and more extended from the center portion toward an outer circumferential portion of the material to be transferred. As a result, in the micropattern transfer device, flowability of a resin is excellent, and air bubble entrainment into a pattern forming layer (a resin layer) is prevented. This enables the micropattern transfer device to create a uniform pattern forming layer (a resin layer).

In the transfer device according to Reference 1 or 2, however, the stamper is mechanically bent by holding an end of the stamper with a jig. A load applied to the end of the stamper is large. Repeated transfers may damage the stamper.

Japanese Laid-Open Patent Application, Publication No. 2008-12844 (to be referred to as Reference 3 hereinafter) discloses a transfer device in which a pattern transferred area defined between the stamper and the material to be transferred is made to have a nonuniform pressure distribution, to thereby obtain an excellent flowability of resin.

In the transfer device, however, the larger an area on which a pattern is transferred becomes, the larger a load to be applied to the stamper is. If the stamper is made of a not-so-strong material, application of pressure may damage the stamper.

Japanese Laid-Open Patent Application, Publication No. 2008-230027 (to be referred to as Reference 4 hereinafter) discloses a transfer method in which a plurality of nozzles are arranged on a stage on which a stamper is disposed, and fluid discharged from the nozzles bend the stamper in a convex form. More specifically, in the transfer method, a plurality of the nozzles which discharge fluid at different pressures convexly bend the stamper.

In the transfer device of Reference 4, the stamper is convexly bent, thus allowing a uniform pattern forming layer (resin layer) to be formed. Further, a possible damage to the end of the stamper or an indented pattern is reduced, because it is the fluid injected from the nozzles that convexly bends the stamper.

The transfer device of Reference 4, however, has a problem that a configuration of the device becomes complex because different pressures of fluid injected from a plurality of nozzles require their individual control.

Therefore, in the imprinting technique, there is a need for a micropattern transfer stamper capable of forming a uniform pattern forming layer with a simple configuration and not being easily damaged even if used in a transfer step of an indented pattern repeated times; and a micropattern transfer device using the same.

In light of the above problems, the present invention has been made in an attempt to provide a micropattern transfer stamper capable of forming a uniform pattern forming layer with a simple configuration and not being easily damaged even if used in a transfer step of an indented pattern repeated times; and a micropattern transfer device using the same.

### SUMMARY OF THE INVENTION

A micropattern transfer stamper with a fine indented pattern formed thereon comes in contact with a material to be transferred and transfers the fine indented pattern onto the material to be transferred. The micropattern transfer stamper includes: a pattern forming sheet member; and a holding jig that holds the pattern forming sheet member. The holding jig holds an outer circumferential portion of the pattern forming sheet member and defines a space that hermetically contains fluid between itself and a first surface of the pattern forming sheet member on an opposite side of a second surface on which the indented pattern is formed. The second surface on which the indented pattern is formed of the pattern forming sheet member is bent in a convex shape by pressure of the fluid hermetically contained in the space. At least a pattern transferring area composed of the indented pattern on the second surface deforms following the surface of the material to be transferred, when the indented pattern is transferred onto the material to be transferred.

A micropattern transfer device includes: a stamper with a fine indented pattern formed thereon; and a material to be transferred with which the stamper comes in contact and on a surface of which the fine indented pattern is transferred. The stamper includes: a pattern forming sheet member having a flexible sheet, and a pattern forming film formed on a surface of the flexible sheet; and a-holding jig that holds the pattern forming sheet member. The holding jig holds an outer circumferential portion of the pattern forming sheet member and defines a space that hermetically contains fluid between itself and a first surface of the pattern forming sheet member on an opposite side of a second surface on which the indented pattern is formed. The second surface on which the indented pattern is formed of the pattern forming sheet member is bent in a convex shape by pressure of the fluid hermetically contained in the space. At least a pattern transferring area composed of the indented pattern on the second surface deforms following the surface of the material to be transferred, when the indented pattern is transferred onto the material to be transferred.

Other features and advantages of the present invention will become more apparent from the following detailed description of the invention, when taken in conjunction with the accompanying exemplary drawings.

### BRIEF DESCRIPTION OF THE DRAWINGS

FIG. 1A is a view illustrating a configuration of a micropattern transfer device according to a first embodiment. FIG. 1B is a schematic view illustrating a positional relationship between a pattern forming sheet member and a holding jig when viewed from below to upward according to the first embodiment. FIG. 1C is a schematic view illustrating a position of a transparent body of the holding jig when viewed from above to downward according to the first embodiment.

FIG. 2A to FIG. 2D are views for explaining steps of a micropattern transfer method using the micropattern transfer device according to the first embodiment.

FIG. 3 is a view illustrating a configuration of a micropattern transfer device according to a second embodiment.

FIG. 4A to FIG. 4D are views for explaining steps of a micropattern transfer method using the micropattern transfer device according to the second embodiment.

FIG. 5 is a view illustrating a configuration of a micropattern transfer device according to a third embodiment.

FIG. 6 is a SEM image of an indented pattern transferred onto a surface of a material to be transferred in Example 1.

### DETAILED DESCRIPTION OF THE EXEMPLARY EMBODIMENT

### First Embodiment

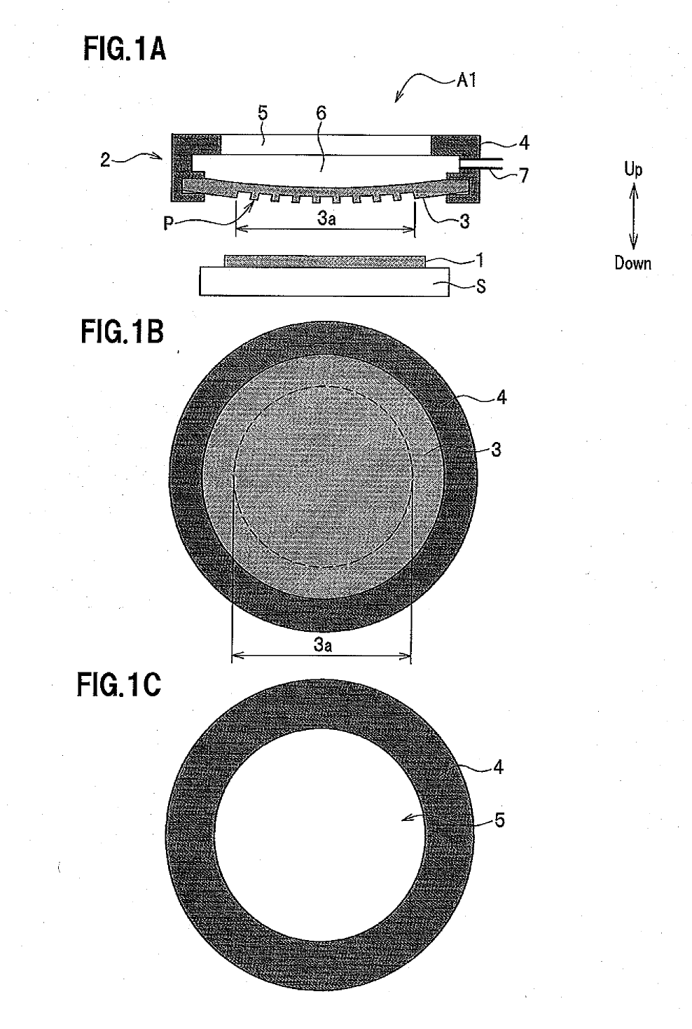

Next is described in detail a first embodiment of the present invention with reference to related drawings. Note that an up and down direction in FIG. 1A is applied to all of the other figures.

As shown in FIG. 1A, a micropattern transfer device A1 has a configuration in which a micropattern transfer stamper 2 (which may also be simply referred to as a stamper 2) is brought into contact with a material to be transferred 1, to thereby transfer a fine indented pattern P on (a pattern forming sheet member 3 of) the stamper 2, onto a surface of the material to be transferred 1. The indented pattern P in this embodiment is formed at a nanometer scale.

Methods of forming the indented pattern P include, for example, photolithography, focused ion beam lithography, electron beam writing, and nano imprinting technique. Any of the methods can be selected herein according to a processing accuracy for the indented pattern P to be formed.

As shown in FIG. 1A, the stamper 2 is disposed above the material to be transferred 1 and includes a pattern forming sheet member 3 and a holding jig 4.

The pattern forming sheet member 3 is made of a material having ultraviolet transparency. The pattern forming sheet member 3 has, on a surface thereof facing the material to be transferred 1, a pattern transferred area 3a on which the indented pattern P is formed.

The pattern forming sheet member 3 in this embodiment has a shape of a disk. However, the shape is not limited to this. The pattern forming sheet member 3 may have a round, oval or polygonal shape when viewed from above. The pattern forming sheet member 3 may have a hole at its center. The pattern forming sheet member 3 may have a shape or a surface area different from that of the material to be transferred 1 as long as the pattern forming sheet member 3 can transfer its fine indented pattern P onto a prescribed area on the material to be transferred 1.

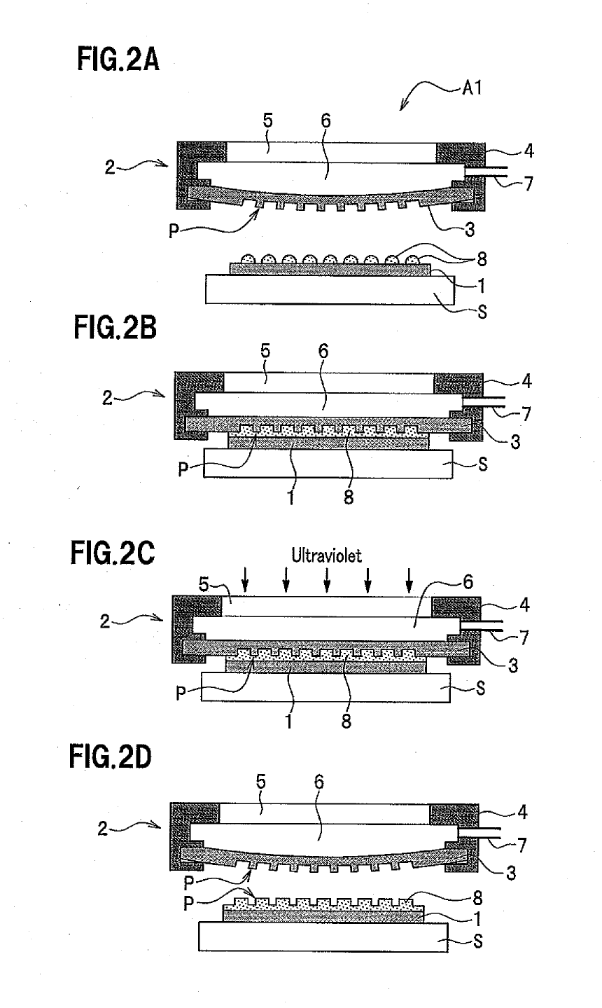

Release treatment based on fluorine, silicone, or the like may be applied to a surface of the pattern forming sheet member 3 so as to facilitate separation from a photo curable resin 8 to be described later (see FIG. 2D). A release layer such as a thin film made of a metal compound may be formed on the surface of the pattern forming sheet member 3.

As shown in FIG. 1B, the holding jig 4 holds an entire outer circumference (which may also be referred to as an outer circumferential portion) of the pattern forming sheet member 3. As shown in FIG. 1A, the holding jig 4 forms a space 6 for hermetically containing fluid, together with a surface of the pattern forming sheet member 3 opposite to the surface on which the indented pattern P is formed. The holding jig 4 may be made of, for example, metal or resin. As shown in FIG. 1A and FIG. 1C, the holding jig 4 includes a transparent body 5 made of a transparent material so as to allow irradiation of ultraviolet to reach the pattern transferred area 3a of the pattern forming sheet member 3. The transparent body 5 in this embodiment is disposed to face a back surface (that is, a surface opposite to the surface on which the indented pattern P is formed) of the pattern forming sheet member 3. The transparent body 5 is made of quartz, glass, resin, or the like.

As described above, the space 6 formed between the pattern forming sheet member 3 and the holding jig 4 (see FIG. 1A) hermetically contains fluid.

A fluid control port 7 is created in the holding jig 4 so as to communicate with the space 6, as shown in FIG. 1A. Pressure of fluid flown into the space 6 through the fluid control port 7 makes the pattern forming sheet member 3 convexly bent in the down direction (that is, toward the material to be transferred 1). The convex shape is not specifically limited as long as it is bent. However, the convex shape is preferably, but not necessarily, spherical.

The fluid control port 7 according to this embodiment is connected to a compressor not shown via a pipe not shown and controls a pressure of fluid in the space 6. The compressor connected to the fluid control port 7 via the pipe may also be referred to as a pressure control mechanism.

Description according to this embodiment assumes that the fluid is a compressible fluid such as air and nitrogen gas. However, the fluid may be an incompressible fluid such as liquid and gel as long as at least a pattern transferring area composed of the indented pattern P on the surface of the pattern forming sheet member 3 can deform following a surface of the material to be transferred 1 at the time of transforming the indented pattern P to be described later. If the incompressible fluid is used, the pattern forming sheet member 3 can deform following a surface of the material to be transferred 1 at the time of transfer under such conditions that the incompressible fluid is hermetically contained in the space 6 together with a compressible fluid or that a pressure of the incompressible fluid in the space 6 is controlled by the above-mentioned pressure control mechanism according to a load applied to the material to be transferred 1.

The material to be transferred 1 is disposed below the pattern forming sheet member 3 and facing the pattern transferred area 3a of the pattern forming sheet member 3, as shown in FIG. 1A. The photo curable resin 8 (see FIG. 2A) on which the indented pattern P is to be transferred is applied on a surface of the material to be transferred 1 which will be described later.

The material to be transferred 1 in this embodiment has a shape of a disk. However, the shape is not limited to this. The material to be transferred 1 may have a round, oval or polygonal shape when viewed from above. The material to be transferred 1 may have a hole at its center.

The material to be transferred 1 is made of, for example, silicon, various metals, glass, quartz, ceramic, or resin. The material to be transferred 1 may be a multilayered structure having a surface composed of a metal layer, a resin layer, an oxide film layer, or the like. The material to be transferred 1 is placed on a stage S having a flat and smooth surface. The material to be transferred 1 is fixed to stage S by mechanical holding, vacuum suction, electrostatic chuck, or any other suitable means.

The stage S can move up and down by an up-and-down mechanism not shown. The stage S is configured to press or separate the material to be transferred 1 against or from the pattern forming sheet member 3. Note that the holding jig 4 may have a driving mechanism not shown for horizontally moving the pattern forming sheet member 3 according to an up and down movement of the stage S. The driving mechanism for the horizontal movement enables a relative alignment of the pattern forming sheet member 3 with respect to the material to be transferred 1.

Next is described a micropattern transfer method using the micropattern transfer device A1 of this embodiment with reference to FIG. 2A to FIG. 2D.

As shown in FIG. 2A, in the micropattern transfer method, fluid is put into the space 6 via the fluid control port 7, to thereby convexly bend the pattern forming sheet member 3 of the stamper 2 toward the material to be transferred 1.

The material to be transferred 1 with the photo curable resin 8 applied thereon is placed on the stage S.

As the photo curable resin 8, a well-known resin material is used such as a resin material with a photosensitive material added thereto. The resin material may be a radical polymerizable material, a cation polymerizable material, an anion polymerizable material, or the like. The resin material includes, for example, a cycloolefin polymer, a polymethyl methacrylate, a polystyrene polycarbonate, a polyethylene terephthalate (PET), a polylactic acid, a polypropylene, a polyethylene, and a polyvinyl alcohol. The photo curable resin 8 may include an appropriate amount of a monomer having a vinyl group, an epoxy group, an oxetanyl group, a methacrylate group, an acrylate group, or the like by mixing.

The photo curable resin 8 may be applied to a surface of the material to be transferred 1 using a dispense method or a spin-coating method, for example. In the dispense method, the photo curable resin 8 is applied onto the surface of the material to be transferred 1 by drops. If the photo curable resin 8 is dropped in different positions on the material to be transferred 1, preferably, but not necessarily, each distance between the centers of the drops is larger than each diameter of the drops. A position of dropping the photo curable resin 8 can be determined by a result of a test on a spread of the photo curable resin 8 corresponding to a desired indented pattern P to be formed. A quantity of the photo curable resin 8 is adjusted to be equivalent to or more than the required for filling up the indented pattern P on the pattern transferred area 3a.

As shown in FIG. 2B, the stage S is lifted up until the material to be transferred 1 is pressed against the pattern forming sheet member 3. The dropped photo curable resin 8 thereby spreads over the surface of the material to be transferred 1 to fill up the indented pattern P of the pattern forming sheet member 3. At this time, the pattern forming sheet member 3 deforms flat following the surface of the material to be transferred 1.

As shown in FIG. 2C, ultraviolet is irradiated onto the photo curable resin 8 through the transparent body 5 of the holding jig 4 and the pattern forming sheet member 3, and the photo curable resin 8 becomes cured.

As shown in FIG. 2D, the stage S is lowered, to thereby separate the material to be transferred 1 from the pattern forming sheet member 3. The surface of the material to be transferred 1 has a layer (a pattern forming layer) made of the cured photo curable resin 8 with the fine indented pattern P transferred thereon.

Next are described advantages and effects of the micropattern transfer device A1 in this embodiment.

In the micropattern transfer device A1, pressure of a fluid hermetically contained in the space 6 bends the pattern forming sheet member 3 of the stamper 2 in a convex form toward the material to be transferred 1. Upon transferring the indented pattern P, a top portion of the bent pattern forming sheet member 3 comes in contact first with a center portion of the material to be transferred 1. Then, the pattern forming sheet member 3 comes in contact more and more with the material to be transferred 1 toward an outer circumferential portion thereof. As a result, in the micropattern transfer device A1, flowability of the photo curable resin 8 applied onto the material to be transferred 1 is excellent, and air bubble entrainment into the photo curable resin 8 is prevented. This enables the micropattern transfer device A1 to create a uniform pattern forming layer (a resin layer) on which the indented pattern P is formed.

In the micropattern transfer device A1, pressure of fluid in the space 6 bends the pattern forming sheet member 3, unlike a conventional transfer device (see, for example, References 1 and 2) in which an end of a stamper (corresponding to the pattern forming sheet member 3 of the present invention) is mechanically pressed and bent. Load applied to an end of the pattern forming sheet member 3 is thus smaller than that in the conventional transfer device, and the pattern forming sheet member 3 of the micropattern transfer device A1 is not easily damaged.

In the micropattern transfer device A1, upon transferring the indented pattern P, the top portion of the bent pattern forming sheet member 3 comes in contact first with the center portion of the material to be transferred 1. Then, the pattern forming sheet member 3 comes in contact more and more with the material to be transferred 1 toward an outer circumferential portion thereof. Thus, the micropattern transfer device A1 is hard to be damaged, unlike a conventional transfer device in which the larger an area on which an indented pattern is transferred, the larger a load to be applied for the transfer (see, for example, Reference 3).

In the micropattern transfer device A1, upon transferring the indented pattern P, pressure of a fluid hermetically contained in the space 6 convexly bends the pattern forming sheet member 3 of the stamper 2 toward the material to be transferred 1. Then, the pattern forming sheet member 3 deforms flat following the surface of the material to be transferred 1, which, in turn, enables a uniform fluid pressure to be applied to the pattern forming sheet member 3. That is, the micropattern transfer device A1 can control flowability of the photo curable resin 8 with a simple structure when the photo curable resin 8 comes in contact with the material to be transferred 1, unlike a conventional transfer device in which fluid is injected from a nozzle disposed on a stage (see, for example, Reference 4).

### Second Embodiment

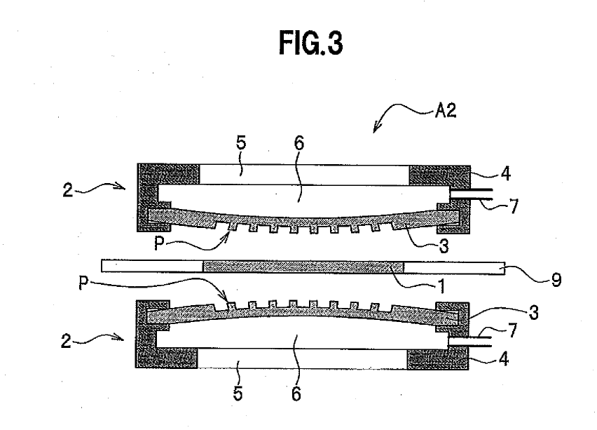

Next is described in detail a second embodiment of the present invention, with reference to FIG. 3. In the second embodiment, the same names are used for the components having the substantially same functions as those in the first embodiment, and description thereof is omitted herefrom.

As shown in FIG. 3, a micropattern transfer device A2 has a configuration in which a pair of stampers 2□2 are disposed across the material to be transferred 1. A pair of the stampers 2, 2 are brought into contact with an upper side surface and a lower side surface of the material to be transferred 1, respectively. Thus, respective fine indented patterns P, P on the pattern forming sheet members 3, 3 are transferred onto the both surfaces of the material to be transferred 1. The stampers 2, 2 have respective up-and down mechanisms (not shown) for pressing or separating respective pattern forming sheet members 3, 3 against or from the material to be transferred 1. The stampers 2, 2 may have respective driving mechanisms (not shown) for horizontally moving themselves in parallel to each other. The driving mechanisms enable a relative alignment between the pattern forming sheet members 3, 3.

A fixture 9 holds the material to be transferred 1. The fixture 9 according to this embodiment is ring-shaped and is configured to have an inner circumferential surface for holding an outer circumferential surface of the material to be transferred 1. However, the configuration of the fixture 9 is not limited to this. For example, the fixture 9 may be configured to pinch an outer edge of the material to be transferred 1 from above and below. In this case, the fixture 9 preferably, but not necessarily, holds the material to be transferred 1 at a position more outside of an area on which the indented pattern P of the pattern forming sheet member 3 is transferred.

In FIG. 3, designated at reference numeral 4 is the holding jig; at 5, the transparent body; at 6, the space; and, at 7, the fluid control port.

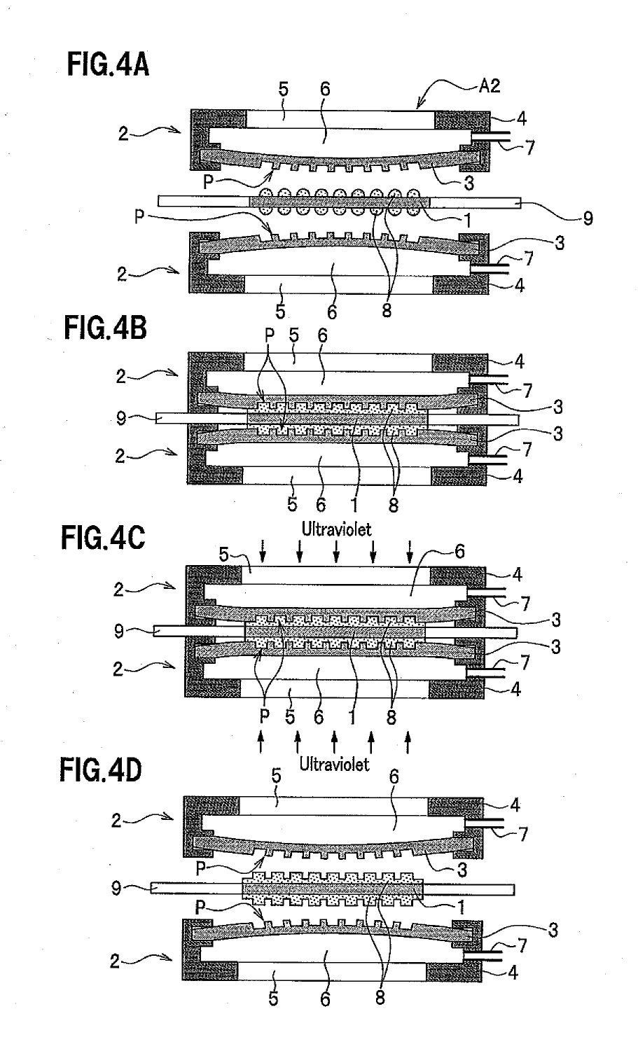

Next is described a micropattern transfer method using the micropattern transfer device A2 according to this embodiment, with reference to FIG. 4A to FIG. 4D.

As shown in FIG. 4A, in the micropattern transfer method, fluid is fed into the space 6 via the fluid control port 7, which convexly bends each of the pattern forming sheet members 3, 3 of the stampers 2, 2 toward the material to be transferred 1.

The photo curable resins 8, 8 are dropped on the both surfaces of the material to be transferred 1 held by the fixture 9. The material to be transferred 1 held by the fixture 9 is disposed to be interposed between the pattern forming sheet members 3, 3.

As shown in FIG. 4B, the pattern forming sheet members 3, 3 of the stampers 2, 2 are respectively pressed against the both surfaces of the material to be transferred 1, to thereby spread the respective photo curable resins 8, Boyer the both surfaces of the material to be transferred 1. At this time, the respective pattern forming sheet members 3, 3 deform flat following the both surfaces of the material to be transferred 1.

As shown in FIG. 4C, ultraviolet is irradiated to the respective photo curable resins 8, 8 through the transparent bodies 5, 5 of the holding jigs 4, 4 and the pattern forming sheet members 3, 3. The photo curable resins 8, 8 then become cured.

As shown in FIG. 4D, the pattern forming sheet members 3, 3 are separated from the material to be transferred 1. Thus, respective micropatterns complementary to the fine indented patterns P, P made of the cured photo curable resins 8, 8 are obtained on the both surfaces of the material to be transferred 1.

The micropattern transfer device A2 as described above has advantages and effects same as those of the micropattern transfer device A1 and also enables to transfer the fine indented patterns P, P on the both surfaces of the material to be transferred 1.

### Third Embodiment

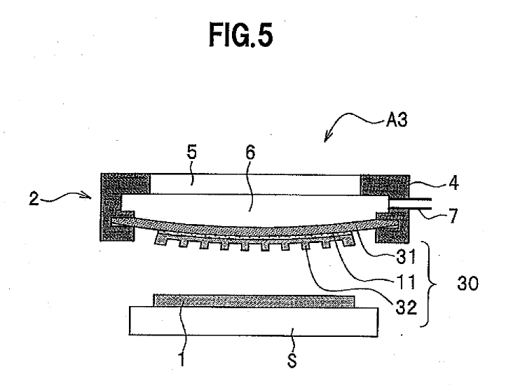

Next is described in detail a third embodiment of the present invention with reference to FIG. 5. In the third embodiment, the same names are used for the components having the substantially same functions as those in the first embodiment, and description thereof is omitted herefrom.

As shown in FIG. 5, the micropattern transfer device A3 according to this embodiment has a configuration similar to that of the micropattern transfer device A1 (see FIG. 1A) according to the first embodiment, except that the micropattern transfer device A3 has a pattern forming sheet member 30, instead of the pattern forming sheet member 3 (see FIG. 1A) of the first embodiment.

The pattern forming sheet member 30 in this embodiment includes a flexible sheet 31, and a pattern forming film 32 formed on a surface of the flexible sheet 31 via an adhesive layer 11.

The flexible sheet 31 is made of, for example, a resin having ultraviolet transparency. In this embodiment, the flexible sheet 31 has a shape of a disk. However, the shape of the flexible sheet 31 is not limited to this. The flexible sheet 31 may have an oval, polygonal or other shape when viewed from the above.

The indented pattern P which corresponds to the pattern transferred area 3a (see FIG. 1A) of the pattern forming sheet member 3 in the first embodiment is formed on the pattern forming film 32. The pattern forming film 32 is made of a material having ultraviolet transparency.

The adhesive layer 11 may be made of an adhesive agent capable of bonding the flexible sheet 31 to the pattern forming film 32. If the pattern forming film 32 is made of a material capable of adhering to the flexible sheet 31, the adhesive layer 11 can be omitted.

The pattern forming sheet member 30 as described above may have a hole at its center.

In FIG. 5, designated at reference numeral 4 is the holding jig; at 5, the transparent body; at 6, the space; at 7, the fluid control port; and, at S, the stage.

The micropattern transfer device A3 as described above has advantages and effects same as those of the micropattern transfer device A1 and also enables to broaden a range of selecting materials for the pattern forming film 32 corresponding to the pattern transferred area 3a and for the flexible sheet 31. This is advantageous in that, for example, a material having a higher mechanical strength can be selected as a material for the flexible sheet 31, thus allowing to manufacture the stamper 2 (the pattern forming sheet member 30) harder to be damaged than the pattern forming sheet member 3. This is because the pattern forming sheet member 3 (see FIG. 1A) is made of a single material, and selection of different material is not available.

The present invention can provide: a micropattern transfer stamper capable of forming a uniform pattern forming layer with a simple configuration and not being easily damaged even if used in a step of transferring an indented pattern repeated times; and a micropattern transfer device using the same.

The first, second, and third embodiments of the present invention have been explained as aforementioned. However, the present invention is not limited to those explanations and can be carried out in various modes.

In the first, second, and third embodiments, the photo curable resin 8 is used as a resin applied to the material to be transferred 1. However, the present invention is not limited to this. The photo curable resin 8 may be replaced by thermoplastic resin, thermo-curing resin, or other resin.

If thermoplastic resin is used as the resin applied to the material to be transferred 1, a temperature of the material to be transferred 1 before being pressed against the pattern forming sheet member 3 or 30 is required to be not less than a glass transition temperature of the thermoplastic resin. After the pattern forming sheet member 3 or 30 is pressed against the material to be transferred 1, the pattern forming sheet member 3 or 30 and the material to be transferred 1 are cooled. This enables the fine indented pattern P on the pattern forming sheet members 3, 30 to be transferred onto a layer made of the cured thermoplastic resin of the material to be transferred 1.

If thermo-curing resin is used as the resin applied to the material to be transferred 1, a temperature of the thermo-curing resin is maintained at a polymerization temperature condition, after the thermo-curing resin is applied between the material to be transferred 1 and the pattern forming sheet member 3 or 30. This enables the fine indented pattern P on the pattern forming sheet member 3 or 30 to be transferred on a layer made of the cured thermo-curing resin of the material to be transferred 1.

If the thermo-curing resin or the thermoplastic resin is used as a resin applied to the material to be transferred 1, the holding jig 4 (including the transparent body 5) and the pattern forming sheet members 3, 30 may each be made of a material not having ultraviolet transparency such as silicon and nickel.

In the second embodiment, the stampers 2, 2 are disposed to sandwich the material to be transferred 1 from above and below. In the present invention, however, another configuration is possible. The material to be transferred 1 may be disposed upright, and the stampers 2, 2 are arranged to sandwich the material to be transferred 1 from right and left.

The material to be transferred 1 on which the fine indented pattern P is transferred using the respective micropattern transfer devices A1, A2, A3 in the first, second, and third embodiments is applicable to an information recording medium such as a magnetic recording medium, an optical recording medium, or the like. The material to be transferred 1 is also applicable to a large-scale integrated circuit component; an optical component such as a lens, a polarizing plate, a wavelength filter, a light emitting device, and an integrated optical circuit; and a biodevice for use in an immune assay, a DNA separation, and a cell culture.

### EXAMPLES

Next are described Examples to explain the present invention more specifically.

### Example 1

In Example 1, the micropattern transfer device A1 shown in FIG. 1A was used.

The holding jig 4 used was made of stainless steel and had the transparent body 5 made of quartz glass and having a diameter of 200 mm and a thickness of 50 mm.

The pattern forming sheet member 3 was prepared by creating the indented pattern P in form of a pattern of grooves, on a round PET sheet having a diameter of 150 mm and a thickness of 0.5 mm. The indented pattern P was created to have successive grooves formed of a plurality of concentric circles with a pitch of 100 nm, using a known thermal nano imprinting method. Each of the grooves had a width of 50 nm and a depth of 80 nm.

Nitrogen gas was injected via the fluid control port 7 in the space 6 of the micropattern transfer device A1 in which the pattern forming sheet member 3 is arranged. Inner pressure of the space 6 was controlled at 0.1 MPa. The pattern forming sheet member 3 was thereby bent in a convex shape.

The material to be transferred 1 used was a round glass substrate having a diameter of 100 mm and a thickness of 0.7 mm. A vacuum suction mechanism not shown and disposed on the stage vacuum-suctioned a back side of the material to be transferred 1, to thereby fix the material to be transferred 1 onto the stage S. The photo curable resin 8 applied to a surface of the material to be transferred 1 was an acrylate resin with a photosensitive substance added thereto and had a viscosity of 4 mPa·s. The photo curable resin 8 was dropped onto the surface of the material to be transferred 1 by a piezo head in which 512 nozzles (256 nozzles×2 rows) were arranged. An amount of a drop of the photo curable resin 8 discharged from each of the nozzles was controlled to be about 14 pL. A pitch of the drops was set at 200 μm in a radial direction and 1,000 μm in a circumferential direction.

After the photo curable resin 8 was dropped onto the material to be transferred 1, the material to be transferred 1 was pressed against the convexly-bent pattern forming sheet member 3 with a pressure of 0.2 MPa for five seconds. At this time, a top portion of the bent pattern forming sheet member 3 came in contact first with a center portion of the material to be transferred 1. Then, the pattern forming sheet member 3 came in contact more and more with the material to be transferred 1 toward an outer circumferential portion thereof. As a result, flowability of the photo curable resin 8 applied onto the material to be transferred 1 was excellent. Air bubble entrainment into the photo curable resin 8 was not observed.

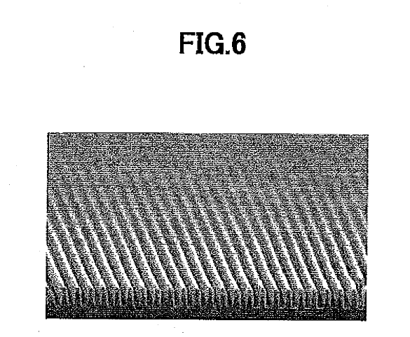

Ultraviolet with an irradiance of 300 mJ/cm² was irradiated to the photo curable resin 8 on the material to be transferred 1 through the transparent body 5 and the pattern forming sheet member 3, to thereby cure the photo curable resin 8. The stamper 2 was separated from the cured photo curable resin 8. The surface of the material to be transferred 1 was observed using SEM. A pattern of grooves complementary to the fine indented pattern P of the pattern forming sheet member 3 was viewed on the surface of the material to be transferred 1. Each of the grooves had a width of 50 nm, a depth of 80 nm, and a pitch of 100 nm. The indented pattern P was formed on a uniform pattern forming layer (a resin layer) having a thickness of 10 nm. FIG. 6 is a SEM image of the indented pattern P transferred onto the material to be transferred 1 in Example 1.

The above-described transfer of the indented pattern P was repeated 100 times using the same micropattern transfer device A1. The pattern forming sheet member 3 was not damaged.

### Example 2

In Example 2, the micropattern transfer device A2 shown in FIG. 3 was used.

The material to be transferred 1 used was a round glass substrate having a diameter of 65 mm and a thickness of 0.7 mm. The fixture 9 made of stainless steel held an outer circumferential portion of the material to be transferred 1.

A pair of the pattern forming sheet members 3, 3 each of which was similar to that used in Example 1 were disposed to interpose the material to be transferred 1 from above and below.

The micropattern transfer device A2 was used for transferring the fine indented patterns P, P on the both surfaces of the material to be transferred 1.

The photo curable resins 8, 8 were applied onto the both surfaces of the material to be transferred 1 on the same condition as that of Example 1. The both surfaces of the material to be transferred 1 were pressed against the is respective convexly-bent pattern forming sheet members 3, 3 for five seconds. At this time, respective top portions of the bent pattern forming sheet members 3, 3 came in contact first with respective center portions of the material to be transferred 1. Then, the pattern forming sheet members 3, 3 came in contact more and more with the both surfaces of the material to be transferred 1 toward respective outer circumferential portions thereof. As a result, flowability of the photo curable resins 8, 8 applied onto the material to be transferred 1 was excellent. Air bubble entrainment into the photo curable resins 8, 8 was not observed.

Ultraviolet with an irradiance of 300 mJ/cm² was irradiated to the photo curable resins 8, 8 on the both sides of the material to be transferred 1 through the respective transparent bodies 5, 5 and the pattern forming sheet members 3, 3 to thereby cure the photo curable resins 8, 8. The pattern forming sheet members 3, 3 were respectively separated from the cured photo curable resins 8, 8. Respective patterns of grooves complementary to the indented patterns P, P were transferred onto respective uniform pattern forming layers (resin layers) each having a thickness of 10 nm formed on the respective surfaces of the material to be transferred 1. Each of the grooves had a width of 50 nm, a depth of 80 nm, and a pitch of 100 nm.

The above-described transfer of the indented patterns P, P was repeated 100 times using the same micropattern transfer device A2. The pattern forming sheet members 3, 3 were not damaged.

### Example 3

In Example 3, the micropattern transfer device A3 shown in FIG. 5 was used. The pattern forming sheet member 30 was prepared by attaching the pattern forming film 32 to a surface of the flexible sheet 31 with a photo curable resin as the adhesive layer 11. The flexible sheet 31 was made of round-shaped transparent synthetic rubber having a diameter of 150 mm and a thickness of 0.5 mm. The pattern forming film 32 was prepared by creating the fine indented pattern P in form of a pattern of grooves, on a round PET sheet having a diameter of 0.5 mm and a thickness of 0.5 mm, using a known thermal nano imprinting method. The indented pattern P was made up of successive grooves formed of a plurality of concentric circles with a pitch of 100 nm. Each of the grooves had a width of 50 nm and a depth of 80 nm.

The fine indented pattern P was transferred onto the material to be transferred 1 on the same condition as that in Example 1, except that the micropattern transfer device A3 having the pattern forming sheet member 30 was used.

When the material to be transferred 1 was pressed against the convexly-bent pattern forming sheet member 30, a top portion of the bent pattern forming sheet member 30 came in contact first with a center portion of the material to be transferred 1. Then, the pattern forming sheet member 30 came in contact more and more with the material to be transferred 1 toward an outer circumferential portion thereof. As a result, flowability of the photo curable resin 8 applied onto the material to be transferred 1 was excellent. Air bubble entrainment into the photo curable resin 8 was not observed. The indented pattern P was formed on a uniform pattern forming layer (resin layer).

The above-described transfer of the indented pattern P was repeated 100 times using the same micropattern transfer device A3. The pattern forming sheet member 30 was not damaged.

### Example 4

In Example 4, the micropattern transfer device A3 shown in FIG. 5 was used. A round PET sheet having a diameter of 150 mm and a thickness of 0.5 mm was used as the flexible sheet 31 of the pattern forming sheet member 30. The adhesive layer 11 was prepared by applying a silane coupling agent (KBM5103 manufactured by Shin-Etsu Silicones K.K.) on a surface of the round PET sheet. The pattern forming film 32 was formed on the adhesive layer 11 by the nano imprinting method using a photo curable resin. The pattern forming film 32 was same as the fine indented pattern P in Example 1 and had a pattern of grooves with a width of 50 nm, a depth of 80 nm, and a pitch of 100 nm.

The fine indented pattern P was transferred onto the material to be transferred 1 on the same condition as that in Example 1, except that the micropattern transfer device A3 having the pattern forming sheet member 30 as described above was used.

When the material to be transferred 1 was pressed against the convexly-bent pattern forming sheet member 30, a top portion of the bent pattern forming sheet member 30 came in contact first with a center portion of the material to be transferred 1. Then, the pattern forming sheet member 30 came in contact more and more with the material to be transferred 1 toward an outer circumferential portion thereof. As a result, flowability of the photo curable resin 8 applied onto the material to be transferred 1 was excellent. Air bubble entrainment into the photo curable resin 8 was not observed. The indented pattern P was formed on a uniform pattern forming layer (resin layer).

The above-described transfer of the indented pattern P was repeated 100 times using the same micropattern transfer device A3. The pattern forming sheet member 30 was not damaged.

### Example 5

In Example 5, a material onto which a micropattern for a large capacity recording medium (a discrete track medium) was transferred was manufactured using the micropattern transfer device A1 in Example 1.

The material to be transferred 1 used was a glass substrate for a magnetic recording medium having a diameter of 65 mm, a thickness of 0.63 mm, and a center hole diameter of 20 mm.

Similarly to Example 1, a pattern of grooves complementary to the indented pattern P on the pattern forming sheet member 3 was formed on a surface of the material to be transferred 1. Each of the grooves had a width of 50 nm, a depth of 80 nm, and a pitch of 100 nm.

### Comparative Example

In Comparative Example, a device same as the micropattern transfer device A1 was used except that the pattern forming sheet member 3 was not previously bent in a convex shape. A transfer was conducted in a method same as that in Example 1. Flowability of the photo curable resin 8 applied on the material to be transferred 1 was too low to form a uniform pattern forming layer on the material to be transferred 1.

The embodiments according to the present invention have been explained as aforementioned. However, the embodiments of the present invention are not limited to those explanations, and those skilled in the art ascertain the essential characteristics of the present invention and can make the various modifications and variations to the present invention to adapt it to various usages and conditions without departing from the spirit and scope of the claims.

1. A micropattern transfer stamper with a fine indented pattern formed thereon which comes in contact with a material to be transferred and transfers the fine indented pattern onto the material to be transferred, the micropattern transfer stamper comprising:
a pattern forming sheet member; and
a holding jig that holds the pattern forming sheet member,
wherein the holding jig holds an outer circumferential portion of the pattern forming sheet member and defines a space that hermetically contains fluid between itself and a first surface of the pattern forming sheet member on an opposite side of a second surface on which the indented pattern is formed,
wherein the second surface on which the indented pattern is formed of the pattern forming sheet member is bent in a convex shape by pressure of the fluid hermetically contained in the space, and
wherein at least a pattern transferring area composed of the indented pattern on the second surface deforms following the surface of the material to be transferred, when the indented pattern is transferred onto the material to be transferred.

2. A micropattern transfer stamper with a fine indented pattern formed thereon which comes in contact with a material to be transferred and transfers the fine indented pattern onto the material to be transferred, the micropattern transfer stamper comprising:
a pattern forming sheet member comprising a flexible sheet, and a pattern forming film formed on a surface of the flexible sheet; and
a holding jig that holds the pattern forming sheet member,
wherein the holding jig holds an outer circumferential portion of the pattern forming sheet member and defines a space that hermetically contains fluid between itself and a first surface of the pattern forming sheet member on an opposite side of a second surface on which the indented pattern is formed,
wherein the second surface on which the indented pattern is formed of the pattern forming sheet member is bent in a convex shape by pressure of the fluid hermetically contained in the space, and
wherein at least a pattern transferring area composed of the indented pattern on the second surface deforms following the surface of the material to be transferred, when the indented pattern is transferred onto the material to be transferred.

3. A micropattern transfer device, comprising:
a stamper with a fine indented pattern formed thereon; and
a material to be transferred with which the stamper comes in contact and on a surface of which the fine indented pattern is transferred,
wherein the stamper comprises a pattern forming sheet member and a holding jig that holds the pattern forming sheet member,
wherein the holding jig holds an outer circumferential portion of the pattern forming sheet member and defines a space that hermetically contains fluid between itself and a first surface of the pattern forming sheet member on an opposite side of a second surface on which the indented pattern is formed,
wherein the second surface on which the indented pattern is formed of the pattern forming sheet member is bent in a convex shape by pressure of the fluid hermetically contained in the space, and
wherein at least a pattern transferring area composed of the indented pattern on the second surface deforms following the surface of the material to be transferred, when the indented pattern is transferred onto the material to be transferred.

4. The micropattern transfer device according to claim 3,
wherein the pattern forming sheet member is made of a material having ultraviolet transparency, and
wherein at least a portion of the holding jig corresponding to the pattern transferring area composed of the indented pattern on the second surface of the pattern forming sheet member which requires to receive radiation of ultraviolet is made of a material having ultraviolet transparency.

5. The micropattern transfer device according to claim 3, further comprising a pressure control mechanism that controls a pressure of the fluid.

6. The micropattern transfer device according to claim 3, wherein the convex shape is spherical.

7. A micropattern transfer device, comprising:
a stamper with a fine indented pattern formed thereon; and
a material to be transferred with which the stamper comes in contact and on a surface of which the fine indented pattern is transferred,
wherein the stamper comprises: a pattern forming sheet member having a flexible sheet, and a pattern forming film formed on a surface of the flexible sheet; and a holding jig that holds the pattern forming sheet member,
wherein the holding jig holds an outer circumferential portion of the pattern forming sheet member and defines a space that hermetically contains fluid between itself and a first surface of the pattern forming sheet member on an opposite side of a second surface on which the indented pattern is formed,
wherein the second surface on which the indented pattern is formed of the pattern forming sheet member is bent in a convex shape by pressure of the fluid hermetically contained in the space, and
wherein at least a pattern transferring area composed of the indented pattern on the second surface deforms following the surface of the material to be transferred, when the indented pattern is transferred onto the material to be transferred.

8. A micropattern transfer device, comprising:
a pair of stampers each with a fine indented pattern formed thereon; and
a material to be transferred with both surfaces of which the respective stampers come in contact and on the both surfaces of which the respective fine indented patterns are transferred,
wherein each of the stampers comprises a pattern forming sheet member and a holding jig that holds the pattern forming sheet member,
wherein each of the holding jigs holds an outer circumferential portion of the pattern forming sheet member and defines a space that hermetically contains fluid between itself and a first surface of the pattern forming sheet member on an opposite side of a second surface on which the indented pattern is formed,
wherein each of the second surfaces on which the indented pattern is formed of the pattern forming sheet member is bent in a convex shape by pressure of the fluid hermetically contained in the space, and
wherein at least each of pattern transferring areas composed of the indented pattern on the second surface deforms following the surface of the material to be transferred, when the indented pattern is transferred onto the material to be transferred.
